(19) United States
(12) Patent Application Publication
(10) Pub. No.: US 2026/0146882 A1
(43) Pub. Date: May 28, 2026

(54) CLAMP-ON ULTRASONIC FLOWMETER

(71) Applicant: Endress+Hauser Flowtec AG, Reinach (CH)

(72) Inventors: Achim Wiest, Weil am Rhein (DE); Sascha Grunwald, Steinen (DE); Andreas Berger, Erschwil (CH); Oliver Brumberg, Rheinfelden (DE)

(73) Assignee: Endress+Hauser Flowtec AG, Reinach (CH)

(21) Appl. No.: 18/994,730

(22) PCT Filed: Jul. 17, 2023
(86) PCT No.: PCT/EP2023/069833

§ 371 Date: Jan. 15, 2025

(30) Foreign Application Priority Data
Jul. 27, 2022 (DE) 10 2022 118 791.8

(51) Int. Cl. G01F 1/66; G01F 1/667

(52) U.S. Cl. CPC G01F 1/662; G01F 1/667

(57) ABSTRACT

A clamp-on ultrasonic flowmeter includes: at least one pair of ultrasonic transducers attached to a pipe; an electronic measuring/operating circuit for operating the ultrasonic transducers, analyzing measurement signals from the ultrasonic transducers, and providing measured values, wherein: the ultrasonic transducers of each pair are each attached separately to the pipe; the pipe has a vertical diameter; and the ultrasonic transducers are mutually spaced circumferentially relative to the vertical diameter; and a counterweight assigned to each ultrasonic transducer and arranged at a distance from the ultrasonic transducer and opposite thereto relative to the vertical diameter, wherein the ultrasonic transducer and the counterweight are connected by a flexible connecting element, which extends exclusively above the pipe.

The invention relates to a clamp-on ultrasonic flowmeter for measuring a flow rate or a volume flow of a medium flowing through a pipe.

Such devices are known, for example, from DE102020116181A1. Ultrasonic transducers are attached to the measuring tube or to the pipe using tensioning belts or magnets, for example. A problem with such devices is the attachment of the individual ultrasonic transducers to a measuring tube or to a pipe, in particular when the ultrasonic transducers are located away from a vertical line of a cross-section of the measuring tube or pipe. In this case, for example, loosening or slipping of the tensioning belt due to temperature fluctuations or slipping of the magnets due to vibrations cause the ultrasonic transducers to be displaced in the direction of gravity.

The object of the invention is to propose a robust and secure attachment for clamp-on ultrasonic transducers.

The object is achieved by a clamp-on ultrasonic flowmeter according to independent claim 1.

A clamp-on ultrasonic flowmeter according to the invention for measuring a flow rate or a volume flow of a medium flowing through a pipe comprises:
at least one ultrasonic transducer, in particular at least one pair of ultrasonic transducers, wherein the at least one ultrasonic transducer is attached to the pipe having an in particular round cross-section or to a measuring tube of the flowmeter, which measuring tube is integrated in the pipe and has an in particular round cross-section,
an electronic measuring/operating circuit for operating the at least one ultrasonic transducer, analyzing measurement signals from the at least one ultrasonic transducer, and providing measured values,
wherein the pipe or the measuring tube has, in cross-sections, a diameter in a longitudinal section containing a pipe axis or measuring tube axis, wherein, in an associated cross-section, the at least one ultrasonic transducer is spaced circumferentially in relation to the diameter,
and is characterized in that
a counterweight, in particular precisely one counterweight (14), is assigned to each ultrasonic transducer and is at a distance from the ultrasonic transducer and opposite thereto in relation to the vertical diameter,
wherein the ultrasonic transducer and the associated counterweight are connected by a flexible, in particular resilient, connecting element, such as a belt, a cable, a chain or a spring, which connecting element extends above, in particular exclusively above, the measuring tube or the pipe,
wherein the flexible connecting element is in a tensioned state by the ultrasonic transducer and the counterweight when the clamp-on flowmeter is arranged on the pipe or on the measuring tube.

In this way, influences, such as temperature fluctuations or vibrations on the positions of the ultrasonic transducers, are reduced.

The flexible connecting element has a spring constant in the longitudinal direction of greater than 50 Newtons per millimeter, and in particular greater than 80 Newtons per millimeter and preferably greater than 100 Newtons per millimeter.

In one embodiment, an ultrasonic transducer of a pair is at a first circumferential distance starting from a starting point to a center of gravity of the corresponding ultrasonic transducer, wherein the associated counterweight is at a second circumferential distance from the vertical diameter,
wherein amounts of the first circumferential distance and the second circumferential distance deviate less than 20% from a mean value of the amounts.

In this way, the effect of displacement on the ultrasonic transducer can be reduced.

In one embodiment, the ultrasonic transducer of a pair has a first mass, wherein the counterweight has a second mass,
wherein the first mass and the second mass deviate less than 20% from a mean value of the masses.

In this way, the effect of displacement on the ultrasonic transducer can be reduced.

In one embodiment, the ultrasonic transducers are attached to the measuring tube or to the pipe, for example, by means of a magnet or a tensioning belt encircling the measuring tube or pipe.

In one embodiment, the counterweight has an anti-slip surface, which surface is in contact with the measuring tube or the pipe.

This better prevents the displacement of the ultrasonic transducer.

In one embodiment, the anti-slip is provided by
a surface structure, such as a pyramid or needle structure,
an elastomer, such as acrylonitrile butadiene rubber or silicone,
or a self-adhesive coating.

In one embodiment, the ultrasonic transducer and counterweight are each attached to the tensioning belt, for example by crimping or screwing.

In one embodiment, the tensioning belt forms the flexible connecting element.

In one embodiment, the flexible connecting element is made of at least one of the following materials:
a metal material, such as steel or in particular stainless steel, or a glass, carbon, polymer or a natural material, such as hemp.

In one embodiment, in the absence of a tensioning belt or a chain, the flexible connecting element has a spring constant in a longitudinal direction of the connecting element of greater than 50 Newtons per millimeter, and in particular greater than 80 Newtons per millimeter and preferably greater than 100 Newtons per millimeter.

In the case of a belt or cable as a flexible connecting element, the materials can be processed in the form of fibers, for example.

In one embodiment, in the presence of a tensioning belt or a chain, the flexible connecting element has a spring constant in a longitudinal direction of the connecting element of greater than 500 Newtons per millimeter, and in particular greater than 800 Newtons per millimeter and preferably greater than 1000 Newtons per millimeter
and/or
wherein the flexible connecting element has a spring constant in a longitudinal direction of the connecting element which is at least a factor of 2 and in particular at least a factor of 4 greater than a spring constant of the tensioning belt or the chain along a corresponding longitudinal direction.

In one embodiment, the clamp-on ultrasonic flowmeter comprises at least two pairs of ultrasonic transducers, wherein one ultrasonic transducer of each of two pairs of ultrasonic transducers forms the counterweight of the other ultrasonic transducer of the two pairs of ultrasonic transducers.

In one embodiment, the counterweight is not designed and/or suitable for generating ultrasonic waves or for receiving ultrasonic waves.

In one embodiment, the counterweight does not have an ultrasonic transducer or no ultrasonic transducer is arranged on the counterweight.

In one embodiment, the ultrasonic transducer, the counterweight and the connecting element are designed such that the ultrasonic transducer remains in its installation position during a mechanical deformation of the pipe or the measuring tube, in particular due to temperature.

The invention will now be described with reference to exemplary embodiments.

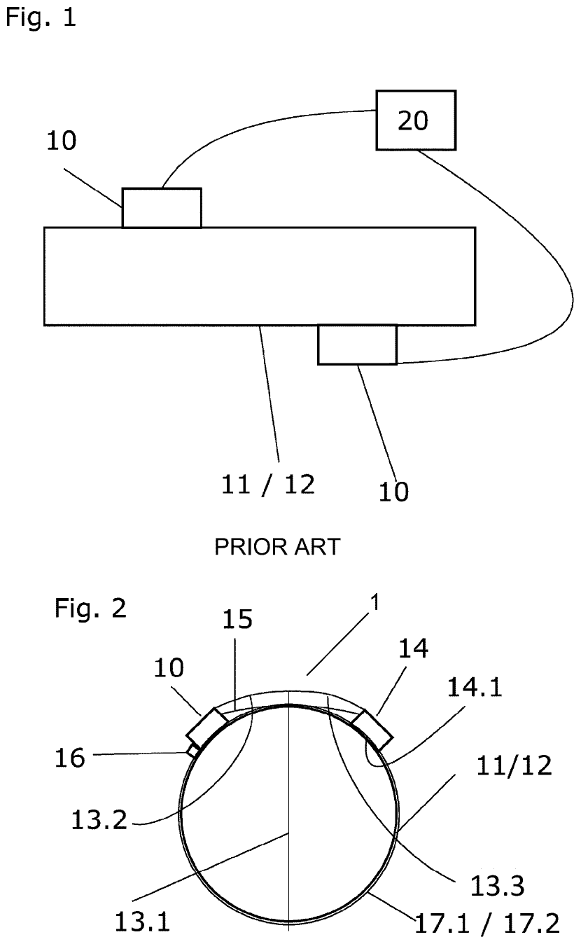

FIG. 1 is a side view of an exemplary schematic clamp-on ultrasonic flowmeter according to the prior art;

FIG. 2 is a front view of an exemplary schematic implementation of the invention.

FIG. 1 shows an exemplary clamp-on ultrasonic flowmeter having two ultrasonic transducers which are arranged on a measuring tube 12 integrated into a pipe or on a pipe 11 and are configured to mutually send and receive ultrasonic signals. An electronic measuring/operating circuit 20 is configured to operate the ultrasonic transducers, analyze measurement signals from the ultrasonic transducers, and provide measured values. For example, the flow rate or the speed of sound of a medium can be determined from differences in the travel time of ultrasonic signals in and against the direction of flow of a medium in the pipe. Clamp-on ultrasonic flowmeters are known in which the ultrasonic signals pass through the measuring tube or pipe once or several times. Such measuring devices can have one or more pairs of ultrasonic transducers. Doppler measuring devices are also known which only require an ultrasonic transducer for flow measurements.

FIG. 2 is a front view of an exemplary clamp-on ultrasonic flowmeter according to the invention having a pair of ultrasonic transducers, which are arranged one behind the other and send ultrasonic signals having an even-numbered measuring tube or pipe cross-section number through the medium. In terms of basic technical functionality, the same applies as for FIG. 1.

The pipe 11 or the measuring tube 12 each have, in cross-sections, a diameter 13.1 in a longitudinal section containing a pipe axis or measuring tube axis, wherein, in an associated cross-section, the ultrasonic transducers are at a circumferential distance 13.2 in relation to the diameter, wherein a counterweight according to the invention is assigned to each ultrasonic transducer and is at a distance from the ultrasonic transducer and opposite thereto in relation to the vertical diameter.

Further according to the invention, an ultrasonic transducer and an associated counterweight are connected by a flexible connecting element 15, such as a belt or a cable, which connecting element extends above the measuring tube or the pipe, wherein the flexible connecting element is in a state tensioned by the ultrasonic transducer and the counterweight. In this way, a circumferential component of a weight force of the ultrasonic transducer 10 is reduced in magnitude and thus a risk of displacement of the sensor is prevented.

In one embodiment, the counterweight 14 has an anti-slip surface 14.1, which surface is in contact with the measuring tube 12 or the pipe 11. In this way, the ultrasonic transducer can be further stabilized because the counterweight has a secure position. The anti-slip is provided by a surface structure, such as a pyramid or needle structure, or by an elastomer, such as acrylonitrile butadiene rubber or silicone, or by a self-adhesive coating.

In one embodiment, the ultrasonic transducer of a pair each is at a first circumferential distance 13.2 from the vertical diameter, wherein the counterweight is at a second circumferential distance from the vertical diameter, wherein amounts of the first circumferential distance and the second circumferential distance deviate by less than 20% from a mean value of the amounts. This contributes to a better compensation of the circumferential component of the weight force of the ultrasonic transducer.

In one embodiment, the ultrasonic transducer of a pair each has a first mass, wherein the counterweight has a second mass, wherein the first mass and the second mass deviate less than 20% from a mean value of the masses. This contributes to a better compensation of the circumferential component of the weight force of the ultrasonic transducer.

The attachment of the ultrasonic transducers 10 to the measuring tube 12 or to the pipe 11, as shown here, can be effected by means of a magnet 16 and/or a tensioning belt 17.1 or a chain 17.2 encircling the measuring tube or the pipe.

The ultrasonic transducer and counterweight can each be attached to the tensioning belt by crimping or screwing.

In one embodiment, the tensioning belt 17.1 or the chain 17.2 forms the flexible connecting element 15.

In one embodiment, the flexible connecting element has a spring constant in a longitudinal direction of the connecting element of greater than 50 Newtons per millimeter, and in particular greater than 80 Newtons per millimeter and preferably greater than 100 Newtons per millimeter.

In one embodiment, the flexible connecting element has a spring constant in a longitudinal direction of the connecting element of greater than 500 Newtons per millimeter, and in particular greater than 800 Newtons per millimeter and preferably greater than 1000 Newtons per millimeter,
and/or
the flexible connecting element has a spring constant in a longitudinal direction of the connecting element which is at least a factor of 2 and in particular at least a factor of 4 greater than a spring constant of the tensioning belt or the chain along a corresponding longitudinal direction.

The ultrasound signals generated by the ultrasonic transducers can pass through the measuring tube or pipe once or several times, i.e., they can be single-or multi-traverse systems. The number and arrangement of ultrasonic transducers shown in FIG. 2 is purely exemplary. The invention is applicable to all ultrasonic transducer arrangements. For example, the clamp-on ultrasonic flowmeter can comprise a plurality of pairs of ultrasonic transducers, wherein one ultrasonic transducer of each of two different pairs forms the counterweight of the other ultrasonic transducer of the two different pairs.

In one embodiment, the counterweight is not designed and/or suitable for generating ultrasonic waves or for receiving ultrasonic waves. Accordingly, the counterweight itself is not an ultrasonic transducer as in the above embodiment, but a simple inactive, i.e., acoustically inactive, body.

In one embodiment, the counterweight does not have an ultrasonic transducer, or no ultrasonic transducer is arranged on the counterweight. Therefore, the counterweight is also not an adapter sensor adapter for holding an ultrasonic transducer or similar.

In one embodiment, the ultrasonic transducer, the counterweight and the connecting element are designed such that the ultrasonic transducer remains in its installation position during a mechanical deformation of the pipe or the measuring tube, in particular due to temperature. When installing the arrangement on the pipe or measuring tube, the ultrasonic transducer is in its installation position. If the diameter of the pipe or the measuring tube changes due to temperature or pressure-related influences, the ultrasonic transducer does not slip according to the invention, but remains fixed in its original installation position. In this case, the position of the ultrasonic transducer can change radially toward the center, but not in the circumferential direction.

### LIST OF REFERENCE SIGNS

1 Clamp-on ultrasonic flowmeter
10 Ultrasonic transducer
11 Pipe
12 Measuring tube
13.1 Diameter
13.2 Circumferential distance
14 Counterweight
14.1 Anti-slip surface
15 Flexible connecting element
16 Magnet
17.1 Tensioning belt
17.2 Chain
20 Electronic measuring/operating circuit

1-15. (canceled)

16. A clamp-on ultrasonic flowmeter for measuring a flow rate or a volume flow rate of a medium flowing through a pipe having a round cross-section, the clamp-on ultrasonic flowmeter comprising:
at least one ultrasonic transducer configured to be attached to the pipe or to a measuring tube of the flowmeter, which measuring tube is integrated in the pipe and has a round cross-section;
an electronic measuring/operating circuit configured to operate the at least one ultrasonic transducer, analyze measurement signals from the at least one ultrasonic transducer, and provide measured values based on the measurement signals,
wherein the pipe or the measuring tube has, at least in sections, a diameter in a longitudinal cross-section containing a pipe axis or measuring tube axis, respectively,
wherein, in an associated cross-section, the at least one ultrasonic transducer is spaced circumferentially relative to the diameter; and
a counterweight assigned to the at least one ultrasonic transducer and arranged at a distance from the at least one ultrasonic transducer and opposite thereto relative to the diameter,
wherein the at least one ultrasonic transducer and the counterweight are connected by a flexible connecting element, which, when the clamp-on ultrasonic flowmeter is arranged on the pipe or the measuring tube, extends exclusively above the pipe or measuring tube in a tensioned state by the at least one ultrasonic transducer and the counterweight.

17. The clamp-on ultrasonic flowmeter according to claim 16, wherein, when the clamp-on ultrasonic flowmeter is arranged on the pipe or the measuring tube, each ultrasonic transducer is at a first circumferential distance from the vertical diameter starting from a starting point up to a center of gravity of the respective ultrasonic transducer, wherein the corresponding counterweight is at a second circumferential distance from the vertical diameter, and
wherein amounts of the first circumferential distance and the second circumferential distance deviate less than 20% from a mean value of the first and second circumferential distances.

18. The clamp-on ultrasonic flowmeter according to claim 16, wherein each ultrasonic transducer has a first mass, and each counterweight has a second mass, and
wherein the first mass and the second mass deviate less than 20% from a mean value of the first and second masses.

19. The clamp-on ultrasonic flowmeter according to claim 16, wherein the at least one ultrasonic transducer is configured to be attached to the measuring tube or to the pipe by a magnet or by a tensioning belt or chain encircling the measuring tube or the pipe, respectively.

20. The clamp-on ultrasonic flowmeter according to claim 16, wherein the counterweight includes an anti-slip surface, which surface is in contact with the pipe or measuring tube, when the clamp-on ultrasonic flowmeter is arranged on the pipe or the measuring tube, respectively.

21. The clamp-on ultrasonic flowmeter according to claim 20, wherein the anti-slip property of the surface is provided by:
a pyramid or needle surface structure;
an elastomer; or
a self-adhesive coating.

22. clamp-on ultrasonic flowmeter according to claim 19, wherein the at least one ultrasonic transducer and the counterweight are each attached to the tensioning belt or chain by a crimp attachment, screwing, gluing, welding, or riveting.

23. The clamp-on ultrasonic flowmeter according to claim 19, wherein the tensioning belt forms the flexible connecting element.

24. The clamp-on ultrasonic flowmeter according to claim 16, wherein the connecting element is made of at least one of: metal, steel, stainless steel, a glass, carbon, and polymer.

25. The clamp-on ultrasonic flowmeter according to claim 16, wherein the connecting element has a spring constant in a longitudinal direction of the connecting element of greater than 50 Newtons per millimeter.

26. The clamp-on ultrasonic flowmeter according to claim 19, wherein the connecting element has a spring constant in a longitudinal direction of the connecting element of greater than 500 Newtons per millimeter, and/or
wherein the connecting element has a spring constant in a longitudinal direction of the connecting element which is at least a factor of 2 greater than a spring constant of the tensioning belt or the chain along a corresponding longitudinal direction.

27. The clamp-on ultrasonic flowmeter according to claim 16, comprising at least two pair of ultrasonic transducers, wherein one ultrasonic transducer of each of two pair of ultrasonic transducers forms the counterweight of the other ultrasonic transducer of the two pair of ultrasonic transducers.

28. The clamp-on ultrasonic flowmeter according to claim 16, wherein the counterweight is not configured and/or adapted to generate ultrasonic waves or to receive ultrasonic waves.

29. The clamp-on ultrasonic flowmeter according to claim 28, wherein the counterweight does not include an ultrasonic transducer, or no ultrasonic transducer is arranged on the counterweight.

30. The clamp-on ultrasonic flowmeter according to claim 16, wherein the at least one ultrasonic transducer, the counterweight, and the connecting element are configured such that the at least one ultrasonic transducer remains in its installation position during a mechanical deformation of the pipe or the measuring tube.

31. The clamp-on ultrasonic flowmeter according to claim 16, wherein the at least one ultrasonic transducer includes at least one pair of ultrasonic transducers, wherein each ultrasonic transducer has an assigned counterweight.

32. The clamp-on ultrasonic flowmeter according to claim 16, wherein the connecting element is resilient.

33. The clamp-on ultrasonic flowmeter according to claim 16, wherein the connecting element is a belt, a cable, a chain, or a spring.

34. The clamp-on ultrasonic flowmeter according to claim 20, wherein the anti-slip property of the surface is provided by an acrylonitrile butadiene rubber or silicone elastomer.

35. The clamp-on ultrasonic flowmeter according to claim 25, wherein the spring constant is greater than 100 Newtons per millimeter.

36. The clamp-on ultrasonic flowmeter according to claim 19, wherein the connecting element has a spring constant in a longitudinal direction of the connecting element of greater than 1000 Newtons per millimeter, and/or
wherein the connecting element has a spring constant in a longitudinal direction of the connecting element which is at least a factor of 4 greater than a spring constant of the tensioning belt or the chain along a corresponding longitudinal direction.
